(19) United States
(12) Patent Application Publication
(10) Pub. No.: US 2025/0149733 A1
(43) Pub. Date: May 8, 2025

(54) BATTERY SUBSTRATE FOR SEPARATING POSITIVE ELECTRODE AND NEGATIVE ELECTRODE FROM EACH OTHER IN RECHARGEABLE BATTERY, RECHARGEABLE BATTERY COMPRISING SAME, AND METHOD FOR MANUFACTURING BATTERY SUBSTRATE FOR SEPARATING POSITIVE ELECTRODE AND NEGATIVE ELECTRODE FROM EACH OTHER IN RECHARGEABLE BATTERY

(71) Applicant: SAMSUNG SDI CO., LTD., Yongin-si (KR)

(72) Inventors: Gain KIM, Yongin-si (KR); Yongkyoung KIM, Yongin-si (KR); Jinwoo KIM, Yongin-si (KR); Hyungbae KIM, Yongin-si (KR)

(21) Appl. No.: 18/968,005

(22) Filed: Dec. 4, 2024

Related U.S. Application Data
(63) Continuation of application No. 16/628,498, filed on Jan. 3, 2020.

(30) Foreign Application Priority Data
Jul. 3, 2017 (KR) 10-2017-0084402

(51) Int. Cl. H01M 50/431; H01M 50/403; H01M 50/443; H01M 50/446; H01M 50/449; H01M 50/46; H01M 50/491

(52) U.S. Cl. CPC H01M 50/431; H01M 50/403; H01M 50/443; H01M 50/446; H01M 50/449; H01M 50/461; H01M 50/491

(57) ABSTRACT

Provided is a battery substrate for separating positive electrode and negative electrode from each other in rechargeable battery including a substrate, and a coating layer disposed on at least one surface of the substrate, wherein the coating layer comprises inorganic particles and a first binder, and a ratio of an average particle diameter (D50) of the inorganic particles to an average particle diameter (D50) of the first binder is about 1.5:1 to about 2.5:1. When using the battery substrate, the adhesion to an electrode may be improved, thus leading to improved safety and lifetime characteristics of a battery.

### TECHNICAL FIELD

The present disclosure relates to a battery substrate for separating positive electrode and negative electrode from each other in rechargeable battery, a rechargeable battery comprising same, and a method of manufacturing the battery substrate for separating positive electrode and negative electrode from each other in rechargeable battery.

### BACKGROUND ART

In accordance with trends towards small-sized, high-performance devices, it is becoming important to manufacture a smaller, more lightweight rechargeable battery. For applications in the field of electric vehicles, the discharge capacity, energy density, and cycle characteristics of lithium batteries are becoming more important. To satisfy these requirements, there is a need for a rechargeable battery having a high discharge capacity per unit volume, high energy density, and good lifespan characteristics.

To prevent a short circuit in a rechargeable battery, a battery substrate for separating positive electrode and negative electrode from each other in rechargeable battery may be disposed between a positive electrode and a negative electrode of the rechargeable battery. An electrode assembly, which includes the positive electrode, the negative electrode, and the battery substrate between the positive electrode and the negative electrode, may be wound in the form of a jelly roll and then roll-pressed to improve adhesion between the battery substrate and the positive electrode/negative electrode in the electrode assembly.

An olefin polymer is mostly used as a battery substrate for separating positive electrode and negative electrode from each other in rechargeable battery of a rechargeable battery. An olefin polymer has good flexibility, but low strength when soaked with liquid electrolyte, and may lead to a short circuit of a battery due to drastic thermal shrinkage at high temperatures of 100° C. or greater. To solve these problems, there has been suggested a battery substrate for separating positive electrode and negative electrode from each other in rechargeable battery manufactured by coating ceramic on a surface of a porous olefin polymer substrate to improve strength and heat resistance of the battery substrate. However, this ceramic-coated battery substrate may have poor adhesion to the negative electrode/positive electrode and tends to be deformed due to a serious volume change of the battery during charging and discharging.

To improve adhesion between the ceramic-coated battery substrate and the positive electrode/negative electrode, a battery substrate further including a binder on the ceramic has been suggested. However, such a battery substrate including a binder on the ceramic may have increased internal resistance due to a reduced porosity, or may cause swelling of the binder in liquid electrolyte, and thus a rechargeable battery may be more easily deteriorated.

Therefore, there is a need for a battery substrate capable of overcoming these drawbacks of the prior art, minimizing resistance increase, and having improved adhesion and air permeability.

### DESCRIPTION OF EMBODIMENTS

### Technical Problem

Provided is a battery substrate for separating positive electrode and negative electrode from each other in rechargeable battery having improved adhesion strength to a negative electrode and improved air permeability.

Provided is a rechargeable battery including the battery substrate.

Provided is a method of preparing the battery substrate.

### Solution to Problem

According to an aspect of the present disclosure, there is provided a battery substrate for separating a positive electrode and a negative electrode from each other in a rechargeable battery, including a substrate comprising a first surface and a second surface opposing each other; and a coating layer disposed on at least one selected from the first surface and the second surface of the substrate, wherein the coating layer includes inorganic particles and a first binder, and a ratio of an average particle diameter (D50) of the inorganic particles to an average particle diameter (D50) of the first binder is about 1.5:1 to about 2.5:1.

According to another aspect of the present disclosure, there is provided is a rechargeable battery including:
a positive electrode;
a negative electrode; and
the above-described battery substrate disposed between the positive electrode and the negative electrode.

According to another aspect of the present disclosure, there is provided a method of preparing the above-described battery substrate, the method including the steps of:
(a) preparing a slurry including inorganic particles and a first binder; and
(b) applying the slurry onto at least one selected from the first surface and the second surface of the substrate, and drying and roll-pressing a resultant.

### Advantageous Effects of Disclosure

As described above, according to the one or more embodiments, by using the battery substrate including a novel coating layer, the adhesion to the negative electrode and air permeability may be improved, a rechargeable battery may have improved lifetime characteristics.

### BRIEF DESCRIPTION OF DRAWINGS

FIG. 1 is a schematic view of a rechargeable battery according to an example embodiment.

FIG. 2 is a schematic view of a battery substrate according to an example embodiment.

FIG. 3 is a scanning electron microscope (SEM) image of a surface of a battery substrate according to an example embodiment.

FIG. 4 is a SEM image of a cross-section of a battery substrate according to an example embodiment;

FIG. 5 is a schematic view for explaining a preparation process of a battery substrate according to an example embodiment.

FIG. 6 is a graph illustrating change in air permeability with respect to press temperature in a battery substrate according to Example 1.

FIG. 7 is a graph illustrating change in air permeability with respect to press time in the battery substrates of Example 1 and Comparative Example 1.

FIG. 8 is a graph illustrating change in thickness of the battery substrates of Examples 1 to 3 and Comparative Examples 2 to 4.

FIG. 9 is a graph illustrating change in lifetime characteristics for rechargeable batteries of Examples 1 to 3 manufactured using the battery substrates of Preparation Examples 1 to 3, respectively.

### EXPLANATION OF REFERENCE NUMERALS DESIGNATING THE MAJOR ELEMENTS OF THE DRAWINGS

1: Rechargeable battery
2: Negative electrode
3: Positive electrode
4: Battery substrate
5: Battery case
6: Cap assembly

### MODE OF DISCLOSURE

Hereinafter, embodiments of a battery substrate for separating a positive electrode and a negative electrode from each other in a rechargeable battery, the battery substrate, a method of preparing the battery substrate, and a rechargeable battery including the battery substrate will be described in greater detail.

According to an embodiment, a battery substrate for separating a positive electrode and a negative electrode from each other in a rechargeable battery, the battery substrate includes a substrate, and a coating layer disposed on at least one surface of the substrate, wherein the coating layer includes inorganic particles and a first binder, and a ratio of an average particle diameter (D50) of the inorganic particles to an average particle diameter (D50) of the first binder is about 1.5:1 to about 2.5:1. For example, the ratio of the average particle diameters of the inorganic particles to the average particle diameter (D50) of the first binder may be about 1.5:1 to about 2:1,but embodiments are not limited thereto.

When the ratio of the average particle diameter (D50) of the inorganic particles to the average particle diameter (D50) of the first binder satisfies the above ranges, it may be possible to implement an appropriate level of a desorption area in the negative electrode. This may improve the adhesion between the electrode and the battery substrate, thus inhibiting a thickness increase of an electrode assembly including the electrode and the battery substrate, and improving an energy density per unit volume of a rechargeable battery including the electrode assembly. In addition, due to the improved adhesion strength, a volume change during charging and discharging of the rechargeable battery may be inhibited and deterioration of the rechargeable battery caused by volume changes may be inhibited. Furthermore, by controlling the amount of the binder to an appropriate level, deterioration caused from the inclusion of excess binder may be inhibited, and thus the lifetime characteristics of the rechargeable battery may further be improved.

When the average particle diameter (D50) ratio of the inorganic particles to the first binder is as too small as less than 1.5, there may be problems such as a reduction in the adhesion between the electrode and the battery substrate and a thickness increase of the electrode assembly. When the average particle diameter (D50) ratio of the inorganic particles to the first binder is as too large as larger than 2.5, the lifetime of the battery may be deteriorated due to the excess binder.

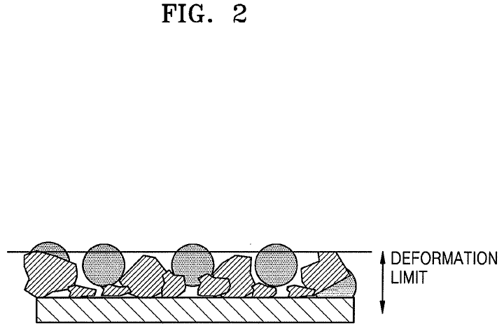

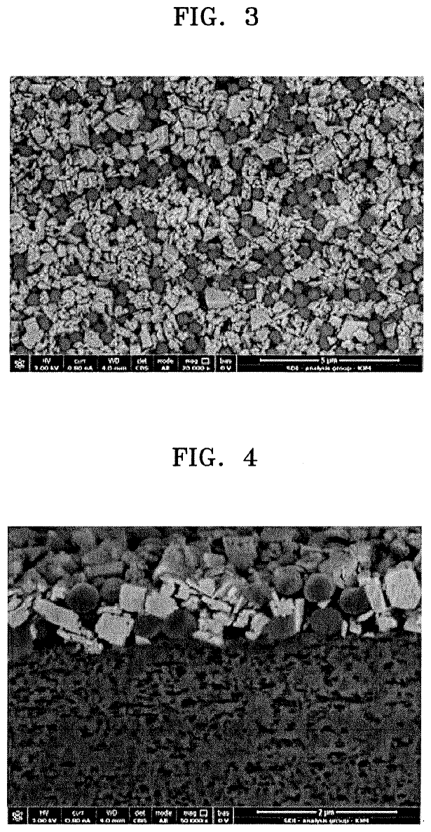

In particular, FIG. 2 is a schematic view of a battery substrate according to an example embodiment, and FIGS. 3 and 4 are scanning electron microscope (SEM) images of a surface and a cross-section of a battery substrate according to an example embodiment, respectively. As shown in FIGS. 2 to 4, the inorganic particles and the first binder may be present mixed together. That is, the coating layer of the battery substrate according to one or more embodiments may consist of a layer in which the binder and the inorganic particles are mixed together, not separate layers consisting of the binder and the inorganic particles, respectively, and the inorganic particles may serve as a deformation limiter of the binder, and thus inhibit internal resistance increase. Therefore, problems with an existing battery substrate in which a binder is added on ceramic, i.e., inorganic particles, such as internal resistance increase resulting from reduced porosity, or swelling of the binder in electrolyte solution may be resolved. In addition, compared with the existing battery substrate which needs to be coated twice, once with the inorganic particle coating layer and once with the binder coating layer, the battery substrate according to one or more embodiments may be coated merely once with a mixed coating layer of inorganic particles and a binder, and therefore there is an effect of reducing the process cost.

For example, the inorganic particles may be present in pores between the first binders. In other words, the first binder may be present in the pores between the inorganic particles. As the inorganic particles are present in the pores between the first binders and vice versa, the coating layer on the battery substrate may have minimized thickness, and a certain level of air permeability may be obtained.

The average particle diameter (D50) of the inorganic particles, though not specifically limited so long as it satisfies the above range of the ratio of the average particle diameter (D50) with respect to that of the first binder, may be about 0.6 μm to about 1.1 μm. For example, the average particle diameter (D50) of the inorganic particles may be about 0.6 to about 0.9 μm. For example, the average particle diameter (D50) of the inorganic particles may be about 0.7 μm to about 0.8 μm.

The average particle diameter (D50) of the first binder, though not specifically limited so long as it satisfies the above range of the ratio of the average particle diameter (D50) with respect to that of the inorganic particles, may be about 0.3 μm to about 0.7 μm. For example, the average particle diameter (D50) of the first binder may be about 0.4 μm to about 0.7 μm. For example, the average particle diameter (D50) of the first binder may be about 0.5 μm to about 0.6 μm.

The first binder may have a glass transition temperature (T_{g}) of about 50° C. to about 100° C. When the glass transition temperature (T_{g}) of the first binder is too high and beyond the above range, a side reaction with electrolyte solution may occur as the press temperature is raised in order to increase the adhesion to the electrode. When the glass transition temperature (T_{g}) of the first binder is too low, filming may occur at the temperature of drying after coating, thus increasing the resistance of a battery.

In one embodiment, the coating layer may have a thickness of about 2 μm or smaller. That is, in the coating layer of the battery substrate according to one or more embodiments, the average particle diameter ratio of the inorganic particles to the binder is limited to be within a certain range, and thus the adhesive strength of the coating layer to the electrode, and the binding strength to the substrate may be increased, enabling the coating layer to be formed as a thin film. For example, the coating layer may have a thickness of about 0.1 μm to about 2 μm. For example, the coating layer may have a thickness of about 0.1 μm to about 1.5 μm. For example, the coating layer may have a thickness of about 0.1 μm to about 1 μm. When the thickness of the coating layer satisfies the above ranges, the battery substrate including the coating layer may provide improved adhesive strength and air permeability. In particular, it may be possible to form a coating layer having a thickness of about 1 μm or smaller, and thus the thickness of an electrode assembly as well as the thickness of the entire battery substrate may be minimized. This may maximize the capacity per volume of a battery.

The coating layer may include about 7 wt % to about 50 wt % of the first binder with respect to a total weight of the coating layer. As described above, since the coating layer of the battery substrate according to one or more embodiments may obtain a certain level of adhesive strength, a relatively small amount of the binder may be used, as compared with an existing battery substrate. This may enable a larger amount of a filler such as the inorganic particles, other than the binder, to be included in the battery substrate.

In particular, the filler may serve as a support in the battery substrate. For example, when the battery substrate is about to shrink at high temperatures, the filler may support the battery substrate and inhibit shrinking of the battery substrate. In addition, since the filler is included in the coating layer disposed on the battery substrate, a sufficient air permeability may be ensured, and mechanical characteristics may be improved. Therefore, a rechargeable battery including the battery substrate in which a relatively large amount of the filler is included by reducing the amount of the binder may obtain improved stability.

For example, the coating layer may be disposed on one or both surfaces of the substrate. The coating layer may be an inorganic layer including the binder, and the inorganic particles as the filler, or an organic-inorganic layer including the binder, and organic particles and inorganic particles as the filler. The coating layer may have a single layer or multi-layer structure.

For example, the coating layer may be disposed on only one surface of the substrate, not on the other surface thereof. The coating layer which is disposed on only one surface of the substrate may be an inorganic layer or an organic-inorganic layer. The coating layer may have a multilayer structure. In the coating layer having a multilayer structure, layers selected from inorganic layers and organic layers may be disposed in any manner. The multilayer structure may be a two-layer structure, a three-layer structure, or a four-layer structure, but is not limited to these structures. Any structure may be selected according to required characteristics of the battery substrate.

For example, the coating layer may be disposed on both surfaces of the substrate. The coating layers respectively disposed on both surfaces of the substrate may each independently be an inorganic layer or an organic-inorganic layer. For examples, the coating layers disposed on both surfaces of the substrate may be all inorganic layers. At least one of the coating layers disposed on both surfaces of the substrate may have a multilayer structure. In the coating layer having a multiplayer structure, layers selected from inorganic layers and organic-inorganic layers may be disposed in any manner. The multilayer structure may be a two-layer structure, a three-layer structure, or a four-layer structure, but is not limited to these structures. Any structure may be selected according to required characteristics of the battery substrate. By the disposing of the coating layers on both surfaces of the substrate, the adhesive strength between the binder and electrode active material layers may be further improved, and thus volume change of a rechargeable battery may be inhibited.

In the battery substrate according to one or more embodiments, the substrate may be a porous substrate. The porous substrate may be a porous membrane including polyolefin. Polyolefin may have a good short-circuit prevention effect and may improve battery stability with a shutdown effect. For example, the porous substrate may be a membrane including a resin, for example, a polyolefin such as polyethylene, polypropylene, polybutene or polyvinyl chloride, a mixture thereof, or a copolymer thereof. However, embodiments are not limited thereto. The porous substrate may be any porous membrane available in the art. For example, the porous substrate may be a porous membrane formed of a polyolefin resin; a porous membrane woven from polyolefin fibers; a nonwoven fabric including polyolefin; or an aggregate of insulating material particles. For example, the porous membrane including polyolefin may ensure a binder solution good coating properties to form the coating layer on the substrate, and may reduce the thickness of the battery substrate, resulting in an increased proportion of the active material in the battery and an increased capacity per unit volume.

For example, polyolefin used as a material of the porous substrate may be a homopolymer such as polyethylene or polypropylene, a copolymer thereof, or a mixture thereof. The polyethylene may be a low-density polyethyelene, a medium-density polyethyelene, or a high-density polyethylene. The high-density polyethylene may be used in view of mechanical strength. To provide flexibility, a mixture of at least two of polyethylenes may be used. A polymerization catalyst used in preparation of polyethylene is not specifically limited, and may be, for example, a Ziegler-Natta catalyst, a Phillips catalyst or a metallocene catalyst. To ensure both mechanical strength and high permeability, the polyethylene may have a weight average molecular weight of about 100,000 to about 12,000,000, and in some embodiments, about 200,000 to about 3,000,000. The polypropylene may be a homopolymer, a random polymer, or a block copolymer, which may be used alone or in combination of at least two. The polymerization catalyst is not specifically limited, and for example, may be a Ziegler-Natta catalyst or a metallocene catalyst. The polyethylene may have any stereoregularity, not specifically limited, for example, in isotactic, syndiotactic, or atactic form. Within the scope not to adversely affect advantages of the disclosure, other polyolefins, except for polyethylene and polypropylene, or an anti-oxidant may be added to the polyolefin.

For example, the porous substrate may be a multilayer including at least two layers and polyolefin such as polyethylene, polypropylene, or the like. For example, the porous substrate may include mixed multiple layers, for example, like a 2-layer battery substrate including polyethylene/polypropylene layers, a 3-layer battery substrate including polyethylene/polypropylene/polyethylene layers, or a 3-layer battery substrate including polypropylene/polyethylene/polypropylene layers. However, embodiments are not limited thereto. For example, any material or any structure used for the porous substrate in the art may be used.

For example, the porous substrate may include a diene polymer prepared by polymerizing a monomer composition including a diene monomer. The diene monomer may be a conjugated diene monomer or a non-conjugated diene monomer. For example, the diene monomer may include at least one selected from the group consisting of 1,3-butadiene, isoprene, 2-chloro-1,3-butadiene, 2,3-dimethyl-1,3-butadiene, 1,3-2-ethyl-1,3-butadiene, pentadiene, chloroprene, vinylpyridine, vinylnorbornene, dicyclopentadiene, and 1,4-hexadiene. However, embodiments are not limited thereto. Any diene monomers available in the art may be used.

In the battery substrate according to one or more embodiments, the porous substrate may have a thickness of about 1 μm to about 100 μm. For example, the porous substrate may have a thickness of about 1 μm to about 30 μm, and in some embodiments, about 5 μm to about 20 μm, and in some other embodiments, about 5 μm to about 15 μm, and in still other embodiments, about 5 μm to about 10 μm. When the thickness of the porous substrate is less than 1 μm, it may be difficult to maintain the mechanical properties of the battery substrate. When the porous substrate of the battery substrate has a thickness greater than 100 μm, the rechargeable battery may have increased internal resistance.

In the battery substrate according to one or more embodiments, the porous substrate may have a porosity of about 5% to about 95%. When the porous substrate has a porosity of less than 5%, the rechargeable battery may have increased internal resistance. When the porous substrate has a porosity greater than 95%, it may be difficult to maintain the mechanical properties of the porous substrate.

In the battery substrate according to one or more embodiments, the porous substrate may have a pore size of about 0.01 μm to about 50 μm. For example, the porous substrate of the battery substrate may have a pore size of about 0.01 μm to about 20 μm, and in some embodiments, about 0.01 μm to about 10 μm. When the pore size of the porous substrate is less than 0.01 μm, the rechargeable battery may have increased internal resistance. When the pore size of the porous substrate exceeds 50 μm, it may be difficult to maintain the mechanical characteristics of the porous substrate.

The inorganic particles may be a metal oxide, a metalloid oxide, or a combination thereof. For example, the inorganic particles may be at least one of alumina (Al₂O₃), boehmite, BaSO₄, MgO, Mg(OH)₂, clay, silica (SiO₂), and TiO₂. These materials such as alumina or silica have a particle size which is small enough to easily form a dispersion. For example, the inorganic particles may be Al₂O₃, SiO₂, TiO₂, SnO₂, CeO₂, NiO, CaO, ZnO, MgO, ZrO₂, Y₂O₃, SrTiO₃, BaTiO₃, MgF₂, Mg(OH)₂, or a combination thereof.

The inorganic particles may be in sphere, plate, or fiber form, but are not limited to these forms. The inorganic particles may have any form available in the art.

The inorganic particles in plate form may be, for example, alumina or boehmite. In this case, reduction in the area of the battery substrate at high temperature may further be inhibited, a relatively large amount of pores may be secured, and a rechargeable battery may exhibit improved characteristics in an penetration test.

When the inorganic particles are in plate or fiber form, the inorganic particles may have an aspect ratio of about 1:5 to about 1:100. For example, the inorganic particles may have an aspect ratio of about 1:10 to about 1:100. For example, the inorganic particles may have an aspect ratio of about 1:5 to about 1:50. For example, the inorganic particles may have an aspect ratio of about 1:10 to about 1:50.

When the inorganic particles are in plate form, a length ratio of the longer axis to the shorter axis on flat plane may be about 1 to about 3. For example, the length ratio of the longer axis to the shorter axis on flat plane may be about 1 to about 2. For example, the length ratio of the longer axis to the shorter axis on flat plane may be about 1. The aspect ratio and the length ratio of the longer axis to the shorter axis may be measured by scanning electron microscopy (SEM). When the aspect ratio and the length ratio of the longer axis to the shorter axis are within the above ranges, shrinkage of the battery substrate may be inhibited, a relatively improved porosity may be secured, and a rechargeable battery may have improved penetration characteristics.

When the inorganic particles are in plate form, an average angle of inorganic particle plate surfaces with respect to one surface of the porous substrate may be about 0 degree to about 30 degrees. For example, the average angle of inorganic particle plate surfaces with respect to one surface of the porous substrate may converge to zero degree. That is, one surface of the porous substrate and the inorganic particle plate surfaces may be parallel. For example, when the average angle of inorganic particle plate surfaces with respect to one surface of the porous substrate is within the above range, thermal shrinkage of the porous substrate may be effectively prevented, and thus a battery substrate with a reduced shrinkage may be provided.

As described above, the coating layer may further include organic particles. The organic particles may be a cross-linked polymer. The organic particles may be a highly cross-linked polymer without a glass transition temperature (T_{g}). When such a highly cross-linked polymer is used, the battery substrate may have improved heat resistance, so that shrinkage of the porous substrate at high temperatures may be effectively suppressed.

The organic particles may include, for example, an acrylate compound and a derivative thereof, a diallyl phthalate compound and a derivative thereof, a polyimide compound and a derivative thereof, a polyurethane compound and a derivative thereof, a copolymer of these compounds, or a combination of these compounds. However, embodiments are not limited thereto. Any material available as a filler in the art may be used. For example, the organic particles may be cross-linked polystyrene particles, or cross-linked polymethyl methacrylate particles.

The inorganic particles or organic particles may be secondary particles formed by aggregation of primary particles. For example, when the battery substrate includes inorganic particles in the form of secondary particles, the coating layer of the battery substrate may have increased porosity, and a rechargeable battery with high output characteristics may be provided.

The coating layers disposed on both surfaces of the battery substrate may have the same composition. By the disposing of the coating layers having the same composition on both surfaces of the battery substrate, substantially the same adhesive strength may act on both surfaces of the battery substrate with respect to corresponding electrode active material layers, thus volume change of the rechargeable battery may be uniformly suppressed.

The first binder included in the coating layer may be an aqueous binder which has a glass transition temperature (T_{g}) of about 50° C. or greater and is present in the form of particles after coating and drying. For example, the first binder may be acrylate or styrene.

In one embodiment, the coating layer may further include a second binder. The second binder may have an average particle diameter (D50) which is smaller than or equal to the average particle diameter (D50) of the first binder. The first binder may serve to improve primarily the adhesion strength to the electrode, and the second binder may serve to improve primarily the adhesion strength to the substrate.

For example, the second binder may be present in at least one group of pores selected from the pores between the inorganic particles, the pores between the first binders, and the pores between the inorganic particles and the first binder.

For example, the second binder may have an average particle diameter (D50) of about 0.2 μm to about 0.4 μm, but embodiments are not limited thereto. For example, the second binder may have an average particle diameter (D50) of about 0.2 μm to about 0.3 μm, but embodiments are not limited thereto.

For example, the second binder may have a glass transition temperature (T_{g}) of about −40° C. or less. For example, the second binder may have a glass transition temperature (T_{g}) of about −80° C. to about −40° C. For example, the second binder may have a glass transition temperature (T_{g}) of about −80° C. to about −50° C. As described above, since the second binder has a low glass transition temperature (T_{g}), the second binder may present in surface contact form after the coating layer is dried.

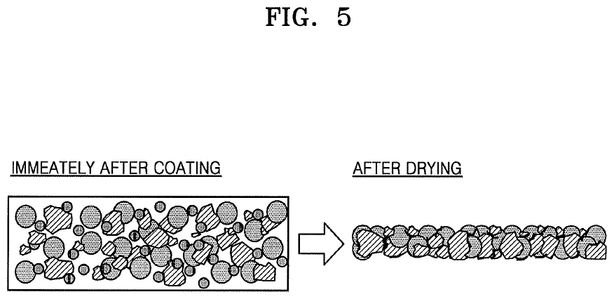

FIG. 5 is a schematic view for explaining a preparation process of the battery substrate according to an example embodiment. Referring to FIG. 5, immediately after coating the coating layer on the substrate, the second binder is present in the pores between the first binder and the inorganic particles. After the coating layer is dried, as described above, the second binder may be present in surface contact form on the substrate.

The second binder may include, though not specifically limited, acrylate. For example, the second binder may be at least one selected from CMC, PVA, PVP, and PAA.

According to an aspect of the disclosure, a method of preparing the battery substrate according one or more embodiments includes: (a) preparing a slurry including inorganic particles and a first binder; and (b) applying the slurry onto at least one surface of the substrate, and then drying and roll-pressing a resultant.

In step (b), the slurry may be coated on both surfaces of the substrate. For example, the slurry may be coated on the both surfaces of the substrate at the same time.

The slurry may additionally further include organic particles or a second binder. The battery substrate may be formed by coating the slurry on the substrate. The method of coating the slurry is not specifically limited, and any coating method available in the art may be used. For example, the battery substrate may be formed by, for example, printing, compression, press fitting, roller coating, blade coating, brush coating, dipping, spraying, or casting.

In the coating layer, the amount of the filler may be about 90% or less with respect to a total weight of the first binder, a second binder, and the filler. When the amount of the filler in the coating layer exceeds 90%, the amounts of the first binder and the second binder may be too low, and thus the adhesion strength between the battery substrate and the electrode active material layers may be reduced.

For example, a ratio of the sum of the first binder and the second binder to the filler in the coating layer may be about 1:1 to about 1:8. For example, a ratio of the sum of the first binder and the second binder to the filler in the coating layer may be about 1:1.5 to about 1:7. For example, a ratio of the sum of the first binder and the second binder to the filler in the coating layer may be about 1:2 to about 1:6. For example, a ratio of the sum of the first binder and the second binder to the filler in the coating layer may be about 1:2 to about 1:5. When the ratio of the sum of the first binder and the second binder to the filler in the coating layer is within these ranges, improved adhesion strength and air permeability may be obtained at the same time. When the amount of the filler is less than the above ranges, the adhesion strength may be improved, while the air permeability may be too low, and thus the internal resistance of a rechargeable battery may be excessively increased. When the amount of the filler is greater than the above ranges, the air permeability may be improved, while the adhesion strength may be excessively reduced.

A peel strength between the battery substrate and the negative electrode may be about 0.01 kgf/mm to about 1.4 kgf/mm. For example, a peel strength between the battery substrate and the negative electrode may be about 0.1 kgf/mm to about 1.0 kgf/mm. For example, a peel strength between the battery substrate and the negative electrode may be about 0.2 kgf/mm to about 0.8 kgf/mm. When the peel strength is within the above ranges, volume change of a rechargeable battery may be effectively inhibited.

The battery substrate may have an air permeability of about 100 seconds to about 900 seconds per 100 mL of air. For example, the battery substrate may have an air permeability of about 170 seconds to about 800 seconds per 100 mL of air, for example, about 170 seconds to about 700 seconds per 100 mL of air, for example, about 170 seconds to about 600 seconds per 100 mL of air, for example, about 170 seconds to about 500 seconds per 100 mL of air, for example, about 170 seconds to about 400 seconds per 100 mL of air, for example, about 170 seconds to about 300 seconds per 100 mL of air, for example, about 170 seconds to about 250 seconds per 100 mL of air. When the air permeability of the battery substrate is within these ranges, internal resistance increase of the rechargeable battery may be effectively inhibited.

According to another aspect of the disclosure, a rechargeable battery includes: a positive electrode; a negative electrode, and the battery substrate according to any of the above-described embodiments between the positive electrode and the negative electrode. By the inclusion of the battery substrate according to any of the embodiments, the rechargeable battery may have the increase adhesion between the electrodes (the positive electrode and the negative electrode) and the battery substrate, and volume changes of the rechargeable battery during charging and discharging may be suppressed. Accordingly, the rechargeable battery may be prevented from deterioration caused due to such volume changes of the rechargeable battery, and thus have improved stability and lifetime characteristics.

A desorption area in the negative electrode of the rechargeable battery may be about 30% to about 80%. When the desorption area in the negative electrode is less than 30%, the adhesion strength may be reduced, and thus the thickness of the electrode assembly may be increased. When the desorption area in the negative electrode exceeds 80%, due to the excess binder, the battery lifetime may be deteriorated.

For example, the rechargeable battery may be manufactured in the following manner.

First, a negative active material, a conducting agent, a binder, and a solvent may be mixed together to prepare a negative active material composition. The negative active material composition may be directly coated on a metallic current collector and dried to form a negative electrode plate. In some embodiments, the negative active material composition may be cast on a separate support to form a negative active material film. This negative active material film may then be separated from the support and laminated on a metallic current collector to thereby form a negative electrode plate. The negative electrode is not limited to the above-described forms, and may have any form.

The negative active material may be a non-carbonaceous material. For example, the negative active material may include at least one selected from lithium metal, a metal that is alloyable with lithium, and alloys and oxides of a metal that is alloyable with lithium.

Examples of the metal alloyable with lithium are Si, Sn, Al, Ge, Pb, Bi, Sb, a Si—Y alloy (wherein Y may be an alkali metal, an alkali earth metal, a Group 13 to Group 16 element, a transition metal, a rare earth element, or a combination thereof, and Y is not Si), and a Sn—Y alloy (wherein Y may be an alkali metal, an alkali earth metal, a Group 13 to Group 16 element, a transition metal, a rare earth element, or a combination thereof, and Y is not Sn). In some embodiments, Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), germanium (Ge), phosphorus (P), arsenic (As), antimony (Sb), bismuth (Bi), sulfur(S), selenium (Se), tellurium (Te), polonium (Po), or combinations thereof.

For example, the negative active material may be a lithium titanium oxide, a vanadium oxide, or a lithium vanadium oxide.

For example, the negative active material may be SnO₂ or SiOₓ (wherein 0<x<2).

For example, the negative active material may be at least one selected from the group consisting of Si, Sn, Pb, Ge, Al, SiOₓ (wherein 0<x≤2), SnO_{y} (wherein 0<y≤2), Li₄Ti₅O₁₂, TiO₂, LiTiO₃, and Li₂Ti₃O₇. However, embodiments are not limited thereto. Any non-carbonaceous negative active material available in the art may be used.

For example, the negative active material may be a composite of a non-carbonaceous negative active material as described above and a carbonaceous material. For example, the negative active material may further include, in addition to such a non-carbonaceous negative active material as described above, and a carbonaceous negative active material.

The carbonaceous material may be crystalline carbon, amorphous carbon, or a mixture thereof. The crystalline carbon may be, for example, graphite such as natural graphite or artificial graphite in amorphous, plate-like, flake-like, spherical or fibrous form. The amorphous carbon may be soft carbon (carbon sintered at low temperatures), hard carbon, meso-phase pitch carbides, sintered cokes, or the like.

The conducting agent may be, for example, natural graphite, artificial graphite, carbon black, acetylene black, ketjen black, carbon fibers, metal powder or metal fibers of such as copper, nickel, aluminum, silver, or the like. For example, the conducting agent may be used together with one or more conductive material such as polyphenylene derivatives. However, embodiments are not limited thereto. Any conducting agent available in the art may be used. The above-listed examples of the crystalline carbonaceous material may be used together as an additional conducting agent.

For example, the binder may be a vinylidene fluoride/hexafluoropropylene copolymer, polyvinylidene fluoride (PVDF), polyacrylonitrile, polymethylmethacrylate, polytetrafluoroethylene, mixtures thereof, and a styrene butadiene rubber polymer. However, embodiments are not limited thereto. Any material available as a binder in the art may be used.

For example, the solvent may be N-methyl-pyrrolidone, acetone, or water. However, embodiments are not limited thereto. Any material available as a solvent in the art may be used.

The amounts of the positive active material, the conducting agent, the binder, and the solvent may be the levels as commonly used in lithium batteries. At least one of the conducting agent, the binder, and the solvent may be omitted according to the use and the structure of the rechargeable battery.

The binder used in the preparation of the negative electrode may be the same as a binder composition included in the coating layer of the battery substrate.

Next, a positive active material, a conducting agent, a binder, and a solvent may be mixed together to prepare a positive active material composition. The positive active material composition may be directly coated on a metallic current collector and dried to form a positive electrode plate. In some embodiments, the positive active material composition may be cast on a separate support to form a positive active material film. This positive active material film may then be separated from the support and laminated on a metallic current collector to thereby form a positive electrode plate.

The positive active material may include at least one selected from the group consisting of lithium cobalt oxide, lithium nickel cobalt manganese oxide, lithium nickel cobalt aluminum oxide, lithium iron phosphate, and lithium manganese oxide. However, embodiments are not limited thereto. Any positive active material available in the art may be used.

For example, the positive active material may be a compound represented by one of the following formulae: LiₐA_{1-b}B_{b}D₂ (wherein 0.90≤a≤1.8, and 0≤b≤0.5); LiₐE_{1-b}B_{b}O_{2-c}D_{c} (wherein 0.90≤a≤1.8, 0≤b≤0.5, and 0≤c≤0.05); LiE_{2-b}B_{b}O_{4-c}D_{c} (wherein 0≤b≤0.5, and 0≤c≤0.05); LiₐNi_{1-b-c}Co_{b}B_{c}D_{α} (wherein 0.90≤a≤1.8, 0≤b≤0.5, 0≤c≤0.05, and 0<α≤2); LiₐNi_{1-b-c}Co_{b}B_{c}O_{2-α}F_{α} (wherein 0.90≤a≤1.8, 0≤b≤0.5, 0≤c≤0.05, and 0<α≤2); LiₐNi_{1-b-c}Co_{b}B_{c}O_{2-α}F₂ (wherein 0.90≤a≤1.8, 0≤b≤0.5, 0≤c≤0.05, and 0<α<2); LiₐNi_{1-b-c}Mn_{b}B_{c}D_{α} (wherein 0.90≤a≤1.8, 0≤b≤0.5, 0≤c≤0.05, and 0<α≤2); LiₐNi_{1-b-c}Mn_{b}B_{c}O_{2-α}F_{α} (wherein 0.90≤a≤1.8, 0≤b≤0.5, 0≤c≤0.05, and 0<α<2); LiₐNi_{1-b-c}Mn_{b}B_{c}O_{2-α}F₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8, and 0.001≤b≤0.1); LiₐCoG_{b}O₂ (wherein 0.90≤a≤1.8, and 0.001≤b≤0.1); LiₐMnG_{b}O₂ (wherein 0.90≤a≤1.8, and 0.001≤b≤0.1); LiₐMn₂G_{b}O₄ (wherein 0.90≤a≤1.8, and 0.001≤b≤0.1); QO₂; QS₂; LiQS₂; V₂O₅; LiV₂O₅; LiIO₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄.

In the formulae above, A may be Ni, Co, Mn, or a combination thereof; B may be Al, Ni, Co, Mn, Cr, Fe, Mg, Sr, V, a rare earth element, or a combination thereof; D may be O, F, S, P, or a combination thereof; E may be Co, Mn, or a combination thereof; F may be F, S, P, or a combination thereof; G may be Al, Cr, Mn, Fe, Mg, La, Ce, Sr, V, or a combination thereof; Q may be Ti, Mo, Mn, or a combination thereof; I may be Cr, V, Fe, Sc, Y, or a combination thereof; and J may be V, Cr, Mn, Co, Ni, Cu, or a combination thereof.

The compounds listed above as positive active materials may have a surface coating layer (hereinafter, also referred to as “coating layer”). Alternatively, a mixture of a compound without a coating layer and a compound having a coating layer, the compounds being selected from the compounds listed above, may be used. In some embodiments, the coating layer may include at least one compound of a coating element selected from the group consisting of oxide, hydroxide, oxyhydroxide, oxycarbonate, and hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. In some embodiments, the coating layer may be formed using any method that does not adversely affect the physical properties of the positive active material when a compound of the coating element is used. For example, the coating layer may be formed using a spray coating method, or a dipping method. The coating methods may be well understood by one of ordinary skill in the art, and thus a detailed description thereof will be omitted.

For example, the positive active material may be LiNiO₂, LiCoO₂, LiMnₓO₂ₓ (wherein x=1 or 2), LiNi₁₋ₓMnₓO₂ (wherein 0<x<1), LiNi_{1-x-y}CoₓMn_{y}O₂ (wherein 0≤x≤0.5 and 0≤y≤0.5), LiFeO₂, V₂O₅, TiS, or MoS.

In some embodiments, the positive active material may be LiCoO₂, LiMnₓO₂ₓ (wherein x=1 or 2), LiNi₁₋ₓMnₓO₂ₓ (wherein 0<x<1), LiNi_{1-x-y}CoₓMn_{y}O₂ (wherein 0≤x≤0.5 and 0≤y≤0.5), or LiFePO₄. The conducting agent, the binder, and the solvent used in the positive active material composition may be the same as those used in the negative active material composition.

In one or more embodiments, a plasticizer may be further added to the positive active material composition and/or the negative active material composition to obtain electrode plates including pores. The amounts of the positive active material, the conducting agent, the binder as a common binder, and the solvent may be the levels as commonly used in lithium batteries.

At least one of the conducting agent, the binder, and the solvent may be omitted according to the use and the structure of the rechargeable battery.

The binder used in the preparation of the positive electrode may be the same as a binder composition included in the coating layer of the battery substrate.

Next, the battery substrate according to any of the above-described embodiments may be disposed between the positive electrode and the negative electrode. In an electrode assembly including the positive electrode, the battery substrate, and the negative electrode, the battery substrate between the positive electrode and the negative electrode may include, as described above, a substrate and a coating layer on at least one surface of the substrate, wherein the coating layer may include inorganic particles and a first binder, and an average particle diameter (D50) ratio of the inorganic particles to the first binder may be about 1.5:1 to about 2.5:1.

The battery substrate according to any of the embodiments may be prepared separately and then disposed between the positive electrode and the negative electrode. In other embodiments, an electrode assembly including a positive electrode, the battery substrate according to any of the embodiments, and a negative electrode as described above may be wound in a jelly roll type, which may then be put into a battery case or a pouch, and thermally soften under pressure. After pre-charging, the charged jelly roll may be subjected to heat pressing, cold pressing, and then a formation process of charging and discharging the jelly roll under pressure and heating conditions, thereby completing the preparation of the battery substrate. A detailed method of preparing a battery substrate will be provided later.

Next, an electrolyte may be prepared.

The electrolyte may be in a liquid or gel state.

For example, the electrolyte may be an organic electrolyte solution. The electrolyte may be in a solid state. For example, the electrolyte may be boron oxide, lithium oxynitride, or the like. However, embodiments are not limited thereto. Any material available as a solid electrolyte in the art may be used. In one or more embodiments, the solid electrolyte may be formed on the negative electrode by, for example, sputtering.

For example, the organic electrolyte solution may be prepared by dissolving a lithium salt in an organic solvent.

The organic solvent may be any solvent available as an organic solvent in the art. For example, the organic solvent may be propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, or a mixture thereof.

In one or more embodiments, the lithium salt may be any material available as a lithium salt in the art. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each independently a natural number), LiCl, LiI, or a mixture thereof.

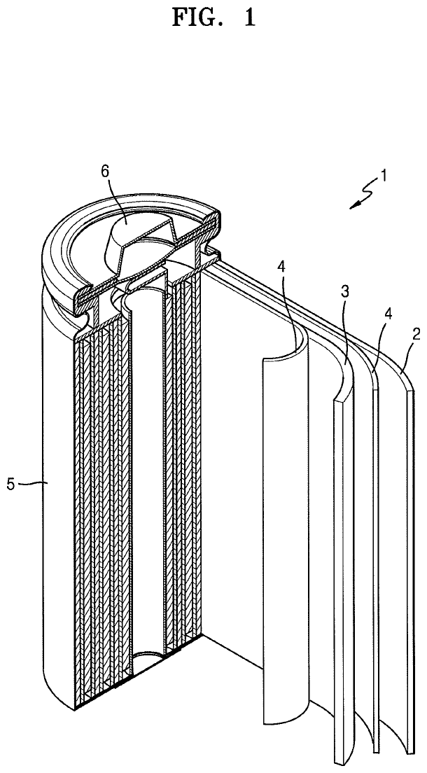

Referring to FIG. 1, a rechargeable battery 1 according to an embodiment may include a positive electrode 3, a negative electrode 2, and a battery substrate 4. The positive electrode 3, the negative electrode 2, and the battery substrate 4 may be wound or folded, and then sealed in a battery case 5. The battery case 5 may be filled with an organic electrolyte solution and sealed with a cap assembly 6, thereby completing the manufacture of the rechargeable battery 1. The battery case 5 may be a cylindrical type, a rectangular type, or a thin-film type. For example, the rechargeable battery 1 may be a thin-film type battery. For example, the rechargeable battery 1 may be a lithium ion battery. For example, the rechargeable battery 1 may be a lithium polymer battery.

In one or more embodiments, the battery substrate may be disposed between the positive electrode and the negative electrode to thereby form an electrode assembly. In some embodiments, the electrode assembly may be stacked on another in a bi-cell structure or wound in a jelly roll type, and then be impregnated with an organic electrolyte solution. The resultant assembly may be put into a pouch and hermetically sealed, thereby completing the manufacture of a lithium ion polymer battery.

In some embodiments, a plurality of electrode assemblies may be stacked to form a battery pack, which may be used in any device that requires high capacity and high output, for example, in a laptop computer, a smart phone, or an electric vehicle.

The rechargeable battery may have improved high rate characteristics and lifetime characteristics, and thus may be used in an electric vehicle (EV), for example, in a hybrid vehicle such as a plug-in hybrid electric vehicle (PHEV).

One or more embodiments of the inventive concept will now be described in detail with reference to the following examples. However, these examples are only for illustrative purposes and are not intended to limit the scope of the one or more embodiments of the inventive concept.

### Preparation of Battery Substrate

### Preparation Example 1

As inorganic particles, about 56 parts by weight of boehmite (BG611, Anhui Estone Materials & Technology Co., Ltd.) having an average particle diameter (D50) of about 0.6 μm and about 19 parts by weight of boehmite (BG601, Anhui Estone Materials & Technology Co., Ltd.) having an average particle diameter (D50) of about 0.4 μm were mixed together to prepare an inorganic dispersion. The prepared inorganic dispersion was mixed with about 21 parts by weight of a first binder (electrode-adhesive binder) having an average particle diameter (D50) of about 0.4 μm and about 4 parts by weight of a second binder (substrate-adhesive binder) having an average particle diameter (D50) of about 0.3 μm to prepare a slurry for forming a coating layer. The first binder was a PMMA-based acrylate binder. The binders had a degree of swelling of about 500% to about 1,500% when left in about 70° C. electrolyte solution for about 72 hours. The degree of swelling of the binders in an electrolyte solution is too low, the adhesion to the electrode may be reduced. The degree of swelling of the binders in an electrolyte solution is too high, the internal resistance of the electrode tends to increase.

The slurry for forming a coating layer was coated by Gravure printing on both surfaces of a porous polyethylene substrate having a thickness of about 6.0 μm to thereby form a battery substrate with a coating layer of a blend of the inorganic particles and the binder on each surface of the porous substrate. The thickness of the coating layer on each surface was about 1.0 μm. The battery substrate had a total thickness of about 8.0 μm.

### Comparative Preparation Example 1

A battery substrate was prepared in the same manner as in Preparation Example 1, except that the amounts of the inorganic particles, the first binder, and the second binder were about 66 parts by weight, about 30 parts by weight, and about 4 parts by weight, respectively.

### Preparation Example 2

A battery substrate was prepared in the same manner as in Preparation Example 1, except that the amounts of the inorganic particles, the first binder, and the second binder were about 78 parts by weight, about 20 parts by weight, and about 2 parts by weight, respectively.

### Preparation Example 3

A battery substrate was prepared in the same manner as in Preparation Example 1, except that the amounts of the inorganic particles, the first binder, and the second binder were about 80 parts by weight, about 17 parts by weight, and about 3 parts by weight, respectively.

### Comparative Preparation Example 2

An about 5-wt % solution of KF75130, which is a polyvinylidene fluoride (PVdF)-based binder, dissolved in a mixed solvent of acetone and dimethylacetamide (DMAc), and an about 10-wt % solution of 21216 binder (having a weight average molecular weight (Mw) of about 500,000 to about 700,000 g/mol, available from Solvay) dissolved in acetone were prepared. About 25 wt % of alumina (LS235, Nippon Light Metal Co., Ltd.) was added to acetone and then dispersed using a bead mill for about 3 hours to prepare an alumina dispersion. The binder solutions and the alumina dispersion were mixed so as to reach a 4:6 weight ratio of KF75130 to 21216 binder and a 1:6 weight ratio of the binder solid content to the alumina solid content, and then acetone was added so as to reach a total solid content of about 11 wt % to thereby prepare a coating solution. The coating solution was coated on a polyethylene fabric (available from SK Ltd.) having a thickness of about 6 μm to form a coated battery substrate having a total thickness of about 8 μm.

### Comparative Preparation Example 3

An acrylic copolymer binder including butyl methacrylate (BMA), methyl methacrylate (MMA) and vinyl acetate (VAc) polymerized in a molar ratio of 3:2:5 was dissolved in acetone to prepare a first binder solution having a solid content of about 5 wt %. KF9300 (having a weight average molecular weight (Mw) of about 1,000,000 to about 1,200,000 g/mol, available from KUREHA CORPORATION), which is a PVdF-based binder, was dissolved in a mixed solvent of acetone and DMAc to prepare a second binder solution having a solid content of about 5 wt %. About 25 wt % of alumina (LS235, Nippon Light Metal Co., Ltd.) was added to acetone and then dispersed using a bead mill for about 3 hours to prepare an alumina dispersion.

The first binder solution, the second binder solution and the alumina dispersion were mixed so as to reach a 6:4 weight ratio of the acrylic binder to the PVdF-based binder and a 1:6 weight ratio of the binder solid content to the alumina solid content, and then acetone was added so as to reach a total solid content of about 12 wt % to thereby prepare a coating solution. The coating solution was coated on both surfaces of a polyethylene fabric (available from SK Ltd.) having a thickness of about 6 um to form a coated battery substrate having a total thickness of about 8 um.

### Comparative Preparation Example 4

An about 5-wt % solution of an acrylic binder, which includes butyl methacrylate (BMA), methyl methacrylate (MMA) and vinyl acetate (VAc) polymerized in a molar ratio of 3:1:6, dissolved in acetone, and an about 7-wt % solution of KF75130, which is a polyvinylidene fluoride (PVdF)-based binder, dissolved in a mixed solvent of acetone and DMAc were prepared. A 10-wt % solution of 21216 binder, which is a PVDF-HFP binder, dissolved in acetone was prepared. About 25 wt % of alumina (LS235, Nippon Light Metal Co., Ltd.) was added to acetone and then dispersed using a bead mill for about 3 hours to prepare an alumina dispersion.

The binder solutions and the alumina dispersion were mixed so as to reach a 5:3:2 weight ratio of the acrylic binder, KF75130, and 21216 binder, and a 1:5 weight ratio of the binder solid content to the alumina solid content, and then acetone was added so as to reach a total solid content of about 10 wt % to thereby prepare a coating solution. The coating solution was coated on both surfaces of a polyethylene fabric (available from SK Ltd.) having a thickness of about 6 um to a thickness of about 1 μm on each surface to form a coated battery substrate having a total thickness of about 8 μm.

### Comparative Preparation Example 5

As inorganic particles, about 56 parts by weight of boehmite (BG611, Anhui Estone Materials & Technology Co., Ltd.) having an average particle diameter (D50) of about 0.6 μm and about 19 parts by weight of boehmite (BG601, Anhui Estone Materials & Technology Co., Ltd.) having an average particle diameter (D50) of about 0.4 μm were mixed together to prepare an inorganic dispersion. The prepared inorganic dispersion and a second binder (acrylate-based, substrate-adhesive binder) having an average particle diameter (D50) of about 0.3 μm were mixed together to prepare a first slurry for forming a coating layer. A second slurry which is a dispersion of a first binder (acrylate-based, electrode-adhesive binder) having an average particle diameter (D50) of about 0.4 μm was prepared. The first slurry, a composition for forming a coating layer, was coated by Gravure printing on both surfaces of a porous polyethylene substrate having a thickness of about 6.0 μm to thereby form a battery substrate with an about 1.0 μm-thick coating layer of a blend of the inorganic particles and the second binder on each surface of the porous substrate. The second slurry was additionally coated on one surface of the coated porous substrate. The thickness of the coating layer on each surface was about 1.0 μm. The battery substrate had a total thickness of about 8.0 μm.

### Manufacture of Rechargeable Battery

### Example 1

### Manufacture of Negative Electrode

97 wt % of graphite particles having an average particle diameter of about 25 μm (C1SR, Nippon Carbon), 1.5 wt % of a styrene-butadiene rubber (SBR) binder (Zeon), and 1.5 wt % of carboxymethylcellulose (CMC, NIPPON A&L) were mixed together, added to distilled water, and then agitated with a mechanical stirrer for about 60 minutes, to thereby prepare a negative active material slurry. The slurry was coated on a copper current collector having a thickness of about 10 μm with a doctor blade, dried in an about 100° C. hot-air drier for about 0.5 hours, dried further under vacuum at about 120° C. for about 4 hours, and then roll-pressed to manufacture a negative electrode plate.

### Manufacture of Positive Electrode

97 wt % of LiCoO₂, 1.5 wt % of carbon black powder as a conducting agent, and 1.5 wt % of polyvinylidene fluoride (PVdF, SOLVAY) were mixed together, added to N-methyl-2-pyrrolidone solvent, and then agitated with a mechanical stirrer for about 30 minutes, to thereby prepare a positive active material slurry. The slurry was coated on an aluminum current collector having a thickness of about 20 μm with a doctor blade, dried in an about 100° C. hot-air drier for about 0.5 hours, dried further under vacuum at about 120° C. for about 4 hours, and then roll-pressed to manufacture a positive electrode plate.

### Electrode Assembly Jelly Roll

The battery substrate prepared in Preparation Example 1 was disposed between the positive electrode plate and the negative electrode plate, and then wound to form an electrolyte assembly in the form of a jelly roll. This jelly roll was put into a pouch. After an electrolyte solution was injected into the pouch, the pouch was vacuum-sealed.

The electrolyte solution included 1.3M LiPF₆ dissolved in a mixed solvent of ethylene carbonate (EC), ethyl methyl carbonate (EMC), and diethyl carbonate (DEC) in a ratio of 3:5:2 (by volume).

While thermally softening the jelly roll in the pouch at about 70° C. under a pressure of about 250 kgf/cm² for about 1 hour, the jelly roll was pre-charged to about 50% of SOC (State of Charge).

The jelly roll was heat-pressed at a temperature of about 85° C. for about 180 seconds under a pressure of about 200 kgf/cm² applied thereto. During the heat pressing, while the binder transitions from a gel state to a sol state, the adhesion force is generated between the positive electrode/negative electrode and the battery substrate.

Subsequently, the jelly roll was cold-pressed at a temperature of about 22-23° C. for about 90 seconds under a pressure of about 200 kgf/cm² applied thereto. During the cold pressing, the binder transitioned from a sol state to a gel state

Then, after degassing the pouch, the jelly roll was charged with a constant current of about 0.2 C rate at about 45° C. under a pressure of about 200 kgf/cm² for about 1 hour until a voltage of about 4.3V was reached, then charged with a constant voltage of about 4.3 V until a cutoff current of about 0.05 C was reached, and then discharged with a constant current of about 0.2 C until a voltage of about 3.0 V was reached. This charge and discharge cycle was repeated 5 times to complete a formation process.

### Examples 2 and 3

Lithium batteries were manufactured in the same manner as in Example 1, except that the battery substrates prepared in Preparation Examples 2 and 3 were used, respectively.

### Comparative Examples 1 to 5

Lithium batteries were manufactured in the same manner as in Example 1, except that the battery substrates prepared in Comparative Preparation Examples 1 to 5 were used, respectively.

### Evaluation Example 1: Battery Substrate Air Permeability Test

After the jelly roll was taken from each of the pouches of Example 1 and Comparative Example 1, which passed through a formation process, the battery substrate was separated from the jelly roll to evaluate air permeability.

The air permeability was measured using a measuring apparatus (EG01-55-1MR, ASAHI SEIKO CO., LTD.), as the time (in seconds) it takes for the battery substrate passed 100 cc of air.

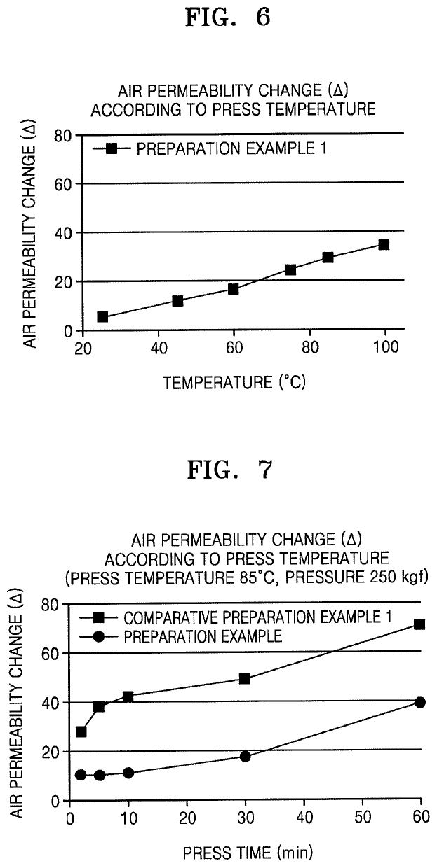

First, changes in air permeability with respect to press temperature in the battery substrate of Example 1 at a press time of 2 minutes were measured. The results are shown in FIG. 6.

Changes in air permeability with respect to press time in the battery substrates of Example 1 and Comparative Example 1 at a press temperature of about 85° C. and a pressure of about 250 kgf were measured. The results are shown in FIG. 7.

Referring to FIG. 7, the battery substrate of Example 1 was found to have improved air permeability, as compared to that of the battery substrate of Comparative Example 1.

### Evaluation Example 2: Battery Substrate Thickness Measurement

To evaluate the behavior of a battery substrate in a battery, the jelly roll in the pouch of each of the lithium batteries of Example 1 and Comparative Example 2 which underwent a formation process was used to measure the thickness of the battery substrate and a thermal mechanical analysis (TMA) thickness. The results are shown in Table 1.

TABLE 1

| | TMA thickness [μm] | | Separator thickness [μm] | |
|---|---|---|---|---|
| | 32 sheets | 1 sheet | Single product | After process |
| Example 1 | 10 | 0.3 | 8 | 7.7 |
| Comparative | 35 | 1.1 | 9 | 7.9 |
| Example 2 | | | | |

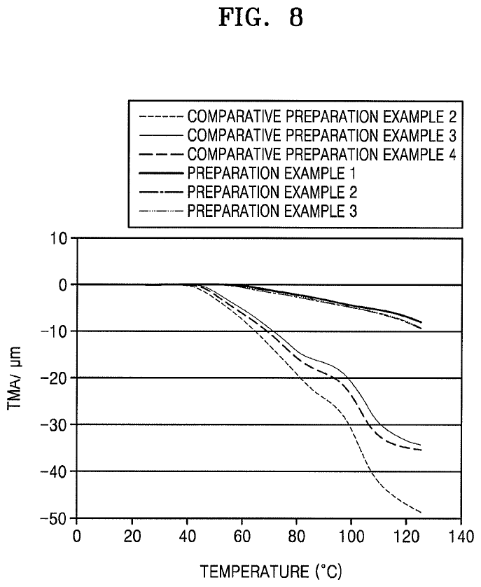

The jelly roll in the pouch of each of the lithium batteries of Examples 1 to 3 and Comparative Examples 2 to 4 which underwent a formation process was used to measure a TMA thickness. The results are shown in FIG. 8.

As shown in Table 1 and FIG. 8, the battery substrates of Examples 1 and 3 had a thickness change of about 0.3 μm to about 0.5 μm at about 120° C. A large change in battery substrate thickness in a battery is considered as a result of deformation of the coating layer, which may lead to increased resistance, due to the deformation of the binder layer in the coating layer, thus affecting cell performance.

### Evaluation Example 3: Test of Adhesion (Adhesive Strength) Between Negative Electrode and Battery Substrate

The adhesive strength between the battery substrate and the electrodes was evaluated using each of the pouched batteries of Examples 1 to 3 and Comparative Examples 1 to 3 which underwent a formation process.

The adhesion between the battery substrate and the positive active material layer or the negative active material layer was measured according to a 3-point bend flexure test (INSTRON). In particular, each pouched cell after the formation process was pressed down at a rate of 5 mm/min to measure a Max value (N, MPa) from the Zero-point to a 5 mm-bending. The results are shown in FIG. 2.

TABLE 2

| | | | | Comparative | Comparative | Comparative |
|---|---|---|---|---|---|---|
| | Example 1 | Example 2 | Example 3 | Example 1 | Example 2 | Example 3 |
| Bending | 249 | 230 | 208 | 309 | 325 | 317 |
| strength | | | | | | |
| (N) | | | | | | |

### Evaluation Example 4: Lifetime Characteristics According to Ratios Between Binder and Inorganic Filler

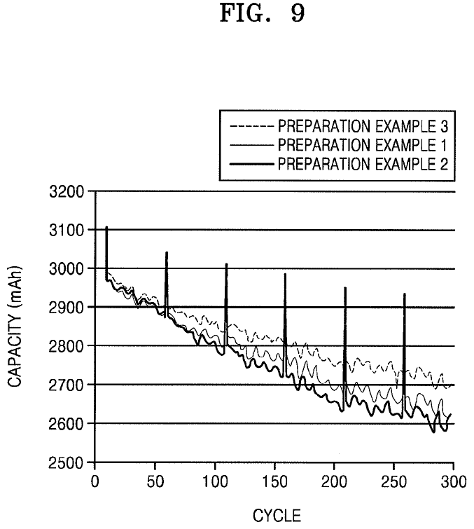

300-cycle lifetime characteristics were evaluated at 1 C per each cycle, using the lithium batteries of Examples 1 to 3 manufactured using the battery substrates of Preparation Examples 1 to 3, respectively. The results are shown in FIG. 9.

### INDUSTRIAL APPLICABILITY

According to the one or more embodiments, by using the battery substrate including a novel coating layer, the adhesion to the negative electrode and air permeability may be improved, a rechargeable battery may have improved lifetime characteristics.

1. A battery substrate for separating a positive electrode and a negative electrode from each other in a rechargeable battery, the battery substrate comprising:
a substrate comprising a first surface and a second surface opposing each other; and
a coating layer disposed on at least one selected from the first surface and the second surface of the substrate,
wherein the coating layer comprises inorganic particles and a binder, the binder comprising a first binder, and a ratio of an average particle diameter (D50) of the inorganic particles to an average particle diameter (D50) of the first binder is 1.5:1 or more and less than 2.0:1, and
wherein, in the coating layer, a weight ratio of the inorganic particles with respect to a total weight of the binder is 3:1 to 4:1.

2. The battery substrate of claim 1, wherein the inorganic particles and the first binder are mixed.

3. The battery substrate of claim 1, wherein the inorganic particles are present in pores between the first binders.

4. The battery substrate of claim 1, wherein the inorganic particles have an average particle diameter (D50) of 0.6 μm to 1.1 μm.

5. The battery substrate of claim 1, wherein the first binder has an average particle diameter (D50) of 0.3 μm to 0.7 μm.

6. The battery substrate of claim 1, wherein the first binder has a glass transition temperature (T_{g}) of 50° C. to 100° C.

7. The battery substrate of claim 1, wherein the coating layer has a thickness of 2 μm or smaller.

8. The battery substrate of claim 1, wherein the coating layer comprises 7 wt % to 50 wt % of the first binder with respect to a total weight of the coating layer.

9. The battery substrate of claim 1, wherein the coating layer is disposed on both surfaces of the substrate.

10. The battery substrate of claim 1, wherein the inorganic particles are at least one selected from alumina (Al₂O₃), boehmite, BaSO₄, MgO, Mg(OH)₂, clay, silica (SiO₂), and TiO₂.

11. The battery substrate of claim 1, wherein the first binder comprises acrylate or styrene.

12. The battery substrate of claim 1, wherein the binder further comprises a second binder, and the second binder has an average particle diameter (D50) that is smaller than or equal to the average particle diameter (D50) of the first binder.

13. The battery substrate of claim 12, wherein the second binder is present in at least one group of pores selected from the pores between the inorganic particles, the pores between the first binders, and the pores between the inorganic particles and the first binder.

14. The battery substrate of claim 12, wherein the second binder has an average particle diameter (D50) of 0.2 μm to 0.4 μm.

15. The battery substrate of claim 12, wherein the second binder has a glass transition temperature (T_{g}) of −40° C. or lower.

16. The battery substrate of claim 12, wherein the second binder is at least one selected from CMC, PVA, PVP, and PAA.

17. A rechargeable battery comprising:
a positive electrode;
a negative electrode; and
the battery substrate of claim 1 interposed between the positive electrode and the negative electrode.

18. The rechargeable battery of claim 17, wherein a desorption area in the negative electrode of the rechargeable battery is 30% to 80%.

19. A method of manufacturing the battery substrate according to claim 1, the method comprising the steps of:
(a) preparing a slurry comprising inorganic particles and a first binder; and
(b) applying the slurry onto at least one selected from the first surface and the second surface of the substrate, and then drying and roll-pressing a resultant.

20. The method of claim 19, wherein, in step (b), the slurry is applied onto the first surface and the second surface of the substrate, wherein the slurry is applied on the first surface and the second surface of the substrate at the same time.
